(19) United States
(12) Patent Application Publication
(10) Pub. No.: US 2016/0269818 A1
(43) Pub. Date: Sep. 15, 2016

(54) MAGNETIC CLIP

(71) Applicant: Luke MACKAY, Montreal (CA)

(72) Inventor: Luke MACKAY, Montreal (CA)

(21) Appl. No.: 14/642,426

(22) Filed: Mar. 9, 2015

(51) Int. Cl. H04R 1/10

(52) U.S. Cl. CPC H04R 1/1033

(57) ABSTRACT

A magnetic clip removably attaches to a cylindrical object as a stem of a transducer housing of an in-ear headphone cord, and includes a main body having a magnet therein. An attachment device extends from the main body, and includes a cylindrical open wall defining a slit that axially extends there along. The cylindrical open wall is resilient for tightly attaching to and clipping around the stem. A set of three clips is used to attach to the stems of the two left and right transducer housings and to the jack of the in-ear headphone cord.

### FIELD OF THE INVENTION

The present invention relates to the field of attachment clips, and is more particularly concerned with a magnetic clip for attaching to a cord and the like.

### BACKGROUND OF THE INVENTION

It is well known in the art to use a magnetic clip to hold an object, or a part thereof, in place onto a metallic surface or simply onto another magnetic clip. More specifically, when referring to earbud (in-ear headphones) cords or the like, it may become expensive to have built-in magnetic devices within the transducer mechanical housings. Accordingly, some magnetic clips are therefore secured to the wire/cord itself, adjacent the transducer housings, as shown in U.S. Pat. No. 7,436,974. In such cases, the magnet clip is either free to slide along the cord, which is not a preferred situation, or is affixed to the cord. In the latter case, they are either non-removable when used with adhesive, or are removable but quite complex in shape and therefore expensive to manufacture.

Accordingly, there is a need for an improved magnetic clip.

### SUMMARY OF THE INVENTION

It is therefore a general object of the present invention to provide an improved magnetic clip.

An advantage of the present invention is that the magnetic clip is relatively simple to manufacture and easily attached onto existing headphones cords, and also easily removable if required.

Another advantage of the present invention is that the set of magnetic clips allows keeping the earbuds where the user wants them when not in use, with no tangle or dangle, while being essentially discreet since aesthetic.

A further advantage of the present invention is that the set of magnetic clips includes a clip for the jack to allow attaching the jack to the earbuds when not used, such as behind the neck of the user to prevent dangling, on a metallic surface as a refrigerator, and the like for quick storage, and also to secure the three extremities of a headphone cord together before storage into a small area such as a pocket and therefore prevent tangling thereof.

Still another advantage of the present invention is that the magnetic clip attaches to a generally cylindrical body or object in a tight manner to prevent its inadvertent sliding or twisting relative thereto.

According to an aspect of the present invention there is provided a magnetic clip for removably attaching to a cylindrical object, said magnetic clip comprising:
a main body including a magnet therein; and
an attachment device extending from the main body, the attachment device includes a generally cylindrical open wall defining a slit axially extending therealong, the cylindrical open wall being resilient for tightly attaching to and clipping around the cylindrical object.

In one embodiment, the main body forms a portion of the cylindrical open wall radially opposite to the slit.

In one embodiment, the main body includes a pair of tabs extending therefrom opposite the attachment device, said tabs generally facing one another and extending on opposite sides relative to the slit.

In one embodiment, the cylindrical open wall includes a resilient inner layer and an outer layer.

Conveniently, an edge of a free end of the cylindrical open wall defining the slit receives a corresponding free end of the first inner layer therein.

According to another aspect of the present invention there is provided a set of at least two magnetic clips, each one of the magnetic clips for removably attaching to a corresponding cylindrical object, each said magnetic clips comprising:
a main body including a magnet therein; and
an attachment device extending from the main body, the attachment device includes a generally cylindrical open wall defining a slit axially extending therealong, the cylindrical open wall being resilient for tightly attaching to and clipping around the corresponding cylindrical object;

wherein the magnets of the at least two magnetic clips are magnetically attractive to one another.

In one embodiment, the set includes two magnetic clips, each said clips for tightly attaching to and clipping around a corresponding transducer housing of an in-ear headphone cord.

In one embodiment, the set includes three magnetic clips, two of said clips for tightly attaching to and clipping around a corresponding transducer housing of an in-ear headphone cord, and a third one of said clips for attaching to and clipping around a jack of the in-ear headphone cord.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective view of a pair of magnetic clips in accordance with an embodiment of the present invention, fixed to a transducer housings of an in-ear headphone cord;

FIG. 2 is a perspective view of a set of three magnetic clips including the pair of FIG. 1 with a third clip fixed to a jack of the in-ear headphone cord;

FIG. 3 is a top perspective view of the set of FIG. 2;

FIG. 4 is a perspective view showing one of the clips of FIG. 1 being fixed to the stem of a transducer housing of the in-ear headphone cord;

FIG. 5 is a perspective view of a magnetic clip in accordance with another embodiment of the present invention, with a pair of tabs;

FIG. 6 is a schematic perspective view of use of the clip of FIG. 5; and

FIG. 7 is a schematic perspective view of another use of the clip of FIG. 5.

### DETAILED DESCRIPTION OF THE INVENTION

With reference to the annexed drawings the preferred embodiment of the present invention will be herein described for indicative purpose and by no means as of limitation.

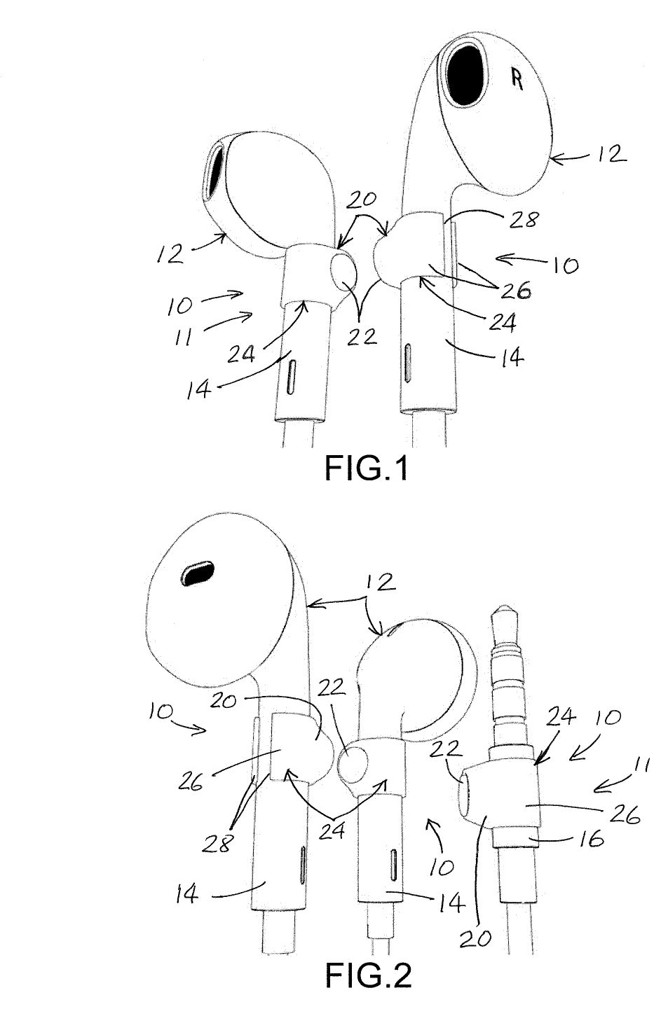

Referring to FIGS. 1 through 4, there is shown a magnetic clip in accordance with an embodiment 10 of the present invention. The magnetic clip 10 of the present invention removably attaches to a cylindrical object and the like, such as a stem of a transducer mechanical housing 14 of an in-ear headphone cord 12, the jack 16 of the in-ear headphone cord 12 or the like. The magnetic clip 10 includes a main body 20 including a magnet 22 therein. The magnet 22 is of any form of magnetic material, either solid or flexible, affixed to or embedded into the body 20. An attachment device 24 extends from the main body 20, and includes a generally cylindrical open wall 26 defining a slit 28 axially extending therealong. The cylindrical open wall 26 is resilient in order to tightly attach to and clip around the cylindrical object 14, 16. To this end, the attachment device 24 is typically made out of plastic type material, or non-magnetic metallic material.

Essentially, the attachment device 24 is in the form of a hollow cylinder opened along its entire length so as to form a resilient device. When the slit 28 is enlarged to force an object to be inserted into the cylindrical open wall 26, it will tend to return to its original size after the insertion, therefore compressing the object if the object is slightly larger than the hollow within the cylindrical open wall 26.

Typically, the main body 20 forms a portion of the cylindrical wall radially opposite to the slit 28.

Accordingly, the present invention also refers to a set 11 of at least two magnetic clips 10, with each magnetic clip 10 removably attaching to a corresponding stem of a transducer mechanical housing 14 of the in-ear headphone cord 12. Typically, in such a case, the magnets 22 of the clips 10 are magnetically attractive to one another (one being positive (+), and the one negative (−)).

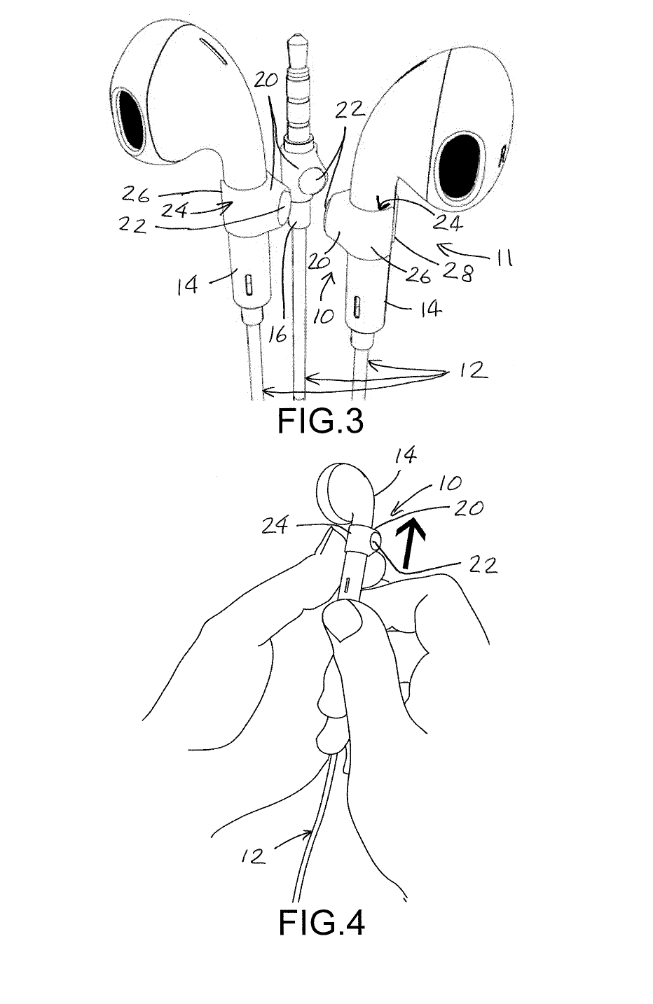

Typically, as shown in FIGS. 2 and 3, the set 11 includes three magnetic clips 10, with the third clip 10 removably attaching to the jack 16 of the in-ear headphone cord 12, by tightly attaching thereto and clipping there around.

Now referring more specifically to FIG. 4, the attachment device 20 of the clip 10 is usually inserted around the cord 12 and the clip 10 is then slid there along until the attachment device 20 tightly surrounds the stem of the transducer mechanical housing 14 of the in-ear headphone cord 12, as illustrated with the arrow.

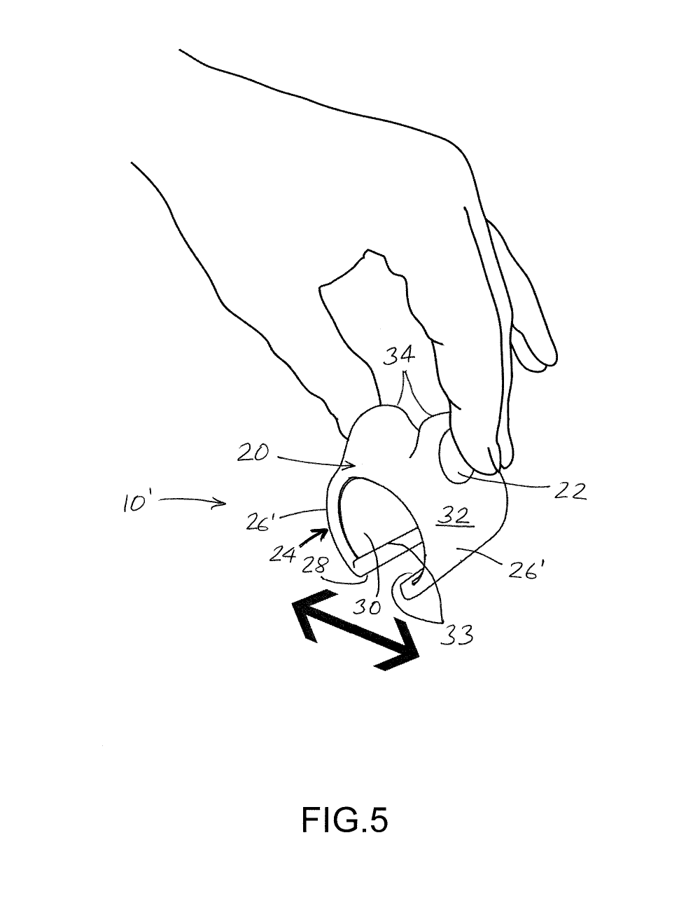

Now referring more particularly to FIG. 5, there is shown a magnetic clip in accordance with another embodiment 10′ of the present invention. The cylindrical open wall 26′ of the attachment device 24 is embodiment 10′ typically includes a first inner layer 30 and an outer layer 32. The inner layer 30 is typically made out of resilient metallic material while the outer layer 32 is typically made out of an aesthetically appealing material such as plastic, silicone or rubber-type material. The edges 33 of the free ends of the wall 26′ defining the slit 28 typically receive the respective free end of the first inner layer therein.

In order to easily temporarily enlarge the slit 28 by pulling the free ends of the cylindrical open wall 26′ along the arrows, the clip 10′ typically includes a pair of tabs 34 or ears extending out from the main body 20 opposite the attachment device 24. The tabs 34 generally face one another and extend on opposite sides relative to the slit 28. As illustrated in FIG. 5, the magnet 22 may be located within one, or both, of the tabs 34.

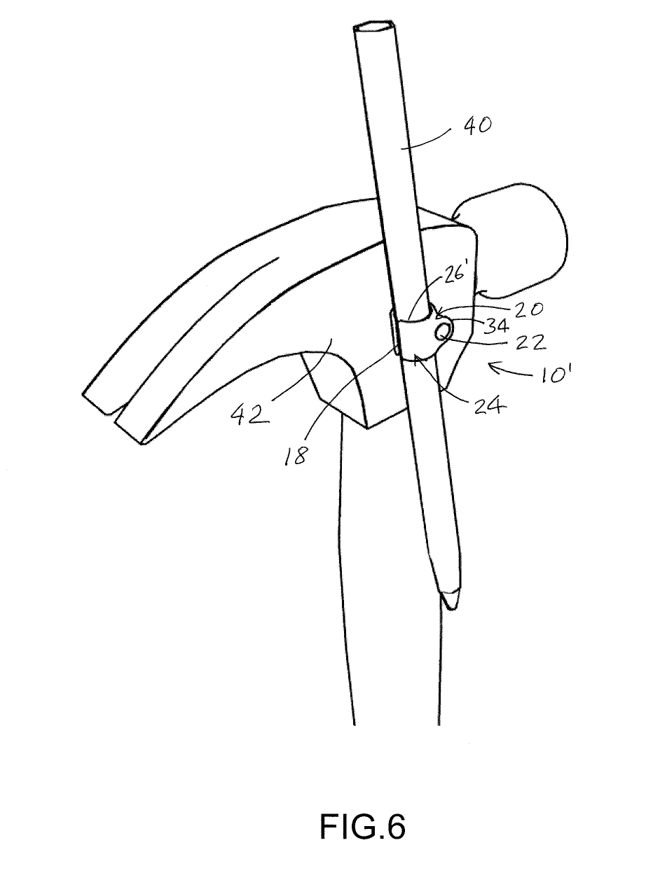

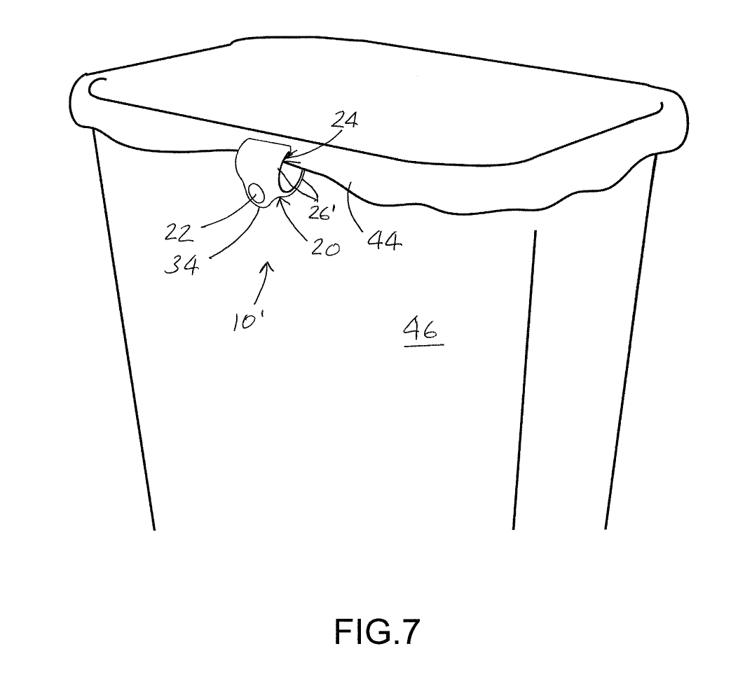

As schematically illustrated in FIGS. 6 and 7 respectively, the magnetic clip 10′ could alternatively be used to hold a pencil 40 against a metallic surface such as a hammer head 42, or simply hold the edge of a garbage plastic bag 44 against a metallic container 46.

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinabove described and hereinafter claimed.

I/We claim:

1. A magnetic clip for removably attaching to a cylindrical object, said magnetic clip comprising:
a main body including a magnet therein; and
an attachment device extending from the main body, the attachment device includes a generally cylindrical open wall defining a slit axially extending therealong, the cylindrical open wall being resilient for tightly attaching to and clipping around the cylindrical object.

2. The magnetic clip of claim 1, wherein the main body forms a portion of the cylindrical open wall radially opposite to the slit.

3. The magnetic clip of claim 2, wherein the main body includes a pair of tabs extending therefrom opposite the attachment device, said tabs generally facing one another and extending on opposite sides relative to the slit.

4. The magnetic clip of claim 1, wherein the cylindrical open wall includes a resilient inner layer and an outer layer.

5. The magnetic clip of claim 4, wherein an edge of a free end of the cylindrical open wall defining the slit receives a corresponding free end of the first inner layer therein.

6. A set of at least two magnetic clips, each one of the magnetic clips for removably attaching to a corresponding cylindrical object, each said magnetic clips comprising:
a main body including a magnet therein; and
an attachment device extending from the main body, the attachment device includes a generally cylindrical open wall defining a slit axially extending therealong, the cylindrical open wall being resilient for tightly attaching to and clipping around the corresponding cylindrical object;
wherein the magnets of the at least two magnetic clips are magnetically attractive to one another.

7. The set of claim 6, wherein the set includes two magnetic clips, each said clips for tightly attaching to and clipping around a corresponding transducer housing of an in-ear headphone cord.

8. The set of claim 6, wherein the set includes three magnetic clips, two of said clips for tightly attaching to and clipping around a corresponding transducer housing of an in-ear headphone cord, and a third one of said clips for attaching to and clipping around a jack of the in-ear headphone cord.
